(19) United States
(12) Patent Application Publication
(10) Pub. No.: US 2019/0143856 A1
(43) Pub. Date: May 16, 2019

(54) SEAT ASSEMBLY THAT INCLUDES A MODULAR FOAM ARRANGEMENT AND A PNEUMATIC BLADDER SUB-ASSEMBLY AND METHOD FOR FABRICATING THE SAME

(71) Applicant: Gulfstream Aerospace Corporation, Savannah, GA (US)

(72) Inventors: Timothy O'Hara, Savannah, GA (US); Richard Davies, Savannah, GA (US); Jeramiah Mallette, Savannah, GA (US)

(73) Assignee: Gulfstream Aerospace Corporation, Savannah, GA (US)

(21) Appl. No.: 15/810,546

(22) Filed: Nov. 13, 2017

(51) Int. Cl. B60N 2/44; B60N 2/64; A61H 9/00

(52) U.S. Cl. CPC B60N 2/448; B60N 2/4415; B60N 2/68; A61H 9/0078; B60N 2/646

(57) ABSTRACT

Seat assemblies and methods for fabricating seat assemblies are provided. In one example, a seat assembly includes a seat frame and a seat cushion that is supported by the seat frame. The seat cushion includes a modular foam arrangement that includes a first modular foam section. A pneumatic bladder sub-assembly is coupled to the first modular foam section. The pneumatic bladder sub-assembly includes a plurality of bladder cells each configured to independently expand and contract to produce movement that is communicated to the first modular foam section. An outer covering at least partially covers the modular foam arrangement.

### TECHNICAL FIELD

The technical field relates generally to seat assemblies, and more particularly, relates to seat assemblies including a seat cushion with a modular foam arrangement and a pneumatic bladder sub-assembly operatively coupled to the modular foam arrangement for translating movement and methods for fabricating such seat assemblies.

### BACKGROUND

The commercial and/or military transportation industries, e.g., aircraft industry, motor vehicle industry, and the like, often include seat assemblies in the aircraft or motor vehicle for comfortably transporting an occupant(s). The seat assemblies include, for example, a seat frame that supports a plurality of seat cushions, such as a seat base cushion and a seat backrest cushion, for providing comfortable seating for an occupant.

During prolonged use of a seat assembly by a seat occupant, the seat assembly may become uncomfortable for the seat occupant. For example, blood flow may become partially restricted particularly in the body regions of the seat occupant that are positioned directly on the seat cushion(s) and that are subject to prolonged, continuous static pressure.

Seat cushions are typically formed from one or more pieces of foam that are hand cut to shape. For example, the seat base cushion can be formed from a single piece of foam that may be subsequently trimmed as needed. Unfortunately, utilizing a single piece of foam to form the seat cushion can make customizing portions of the foam having different properties and/or configurations difficult or impossible.

In another example, the seat base cushion may be formed from multiple hand cut pieces of foam that are glued or bonded together with an adhesive. Unfortunately, the adhesive can produce patchy or random areas of hardness in the foam that can be uncomfortable for the seat occupant.

Accordingly, it is desirable to provide improved seat assemblies including a seat cushion that overcomes one or more of the foregoing concerns. Furthermore, other desirable features and characteristics of the various embodiments described herein will become apparent from the subsequent detailed description and the appended claims, taken in conjunction with the accompanying drawings and this background.

### SUMMARY

Seat assemblies and methods for fabricating seat assemblies are provided herein. In accordance with an exemplary embodiment, a seat assembly includes a seat frame and a seat cushion that is supported by the seat frame. The seat cushion includes a modular foam arrangement that includes a first modular foam section. A pneumatic bladder sub-assembly is coupled to the first modular foam section. The pneumatic bladder sub-assembly includes a plurality of bladder cells each configured to independently expand and contract to produce movement that is communicated to the first modular foam section. An outer covering at least partially covers the modular foam arrangement.

In another exemplary embodiment, a seat assembly includes a seat base portion including a seat base structure portion and a seat base cushion supported by the seat base structure portion. The seat base cushion includes a modular foam arrangement including a first modular foam section. A pneumatic bladder sub-assembly is coupled to the first modular foam section. The pneumatic bladder sub-assembly includes a plurality of bladder cells each configured to independently expand and contract to produce movement that is translate to the first modular foam section. An outer covering at least partially covers the modular foam arrangement. A seat backrest portion is coupled to the seat base portion and is configured to extend substantially upright from a rearward section of the seat base portion. The first modular foam section overlies the pneumatic bladder sub-assembly and extends generally forward of the seat backrest portion.

In accordance with an exemplary embodiment, a method for fabricating a seat assembly is provided. The method includes coupling a pneumatic bladder sub-assembly to a first modular foam section of a modular foam arrangement. The pneumatic bladder sub-assembly includes a plurality of bladder cells each configured to independently expand and contract to produce movement for translation to the first modular foam section. The modular foam arrangement is at least partially covered with an outer covering for forming a seat cushion. The seat cushion is supported by a seat frame.

### BRIEF DESCRIPTION OF THE DRAWINGS

The various embodiments will hereinafter be described in conjunction with the following drawing figures, wherein like numerals denote like elements, and wherein:

FIG. 1 illustrates a perspective view of a seat assembly in accordance with an exemplary embodiment;

FIG. 2 illustrates a side view of a portion of a seat assembly with a seat frame, a seat base cushion, a seat backrest cushion, and a pneumatic bladder sub-assembly in accordance with an exemplary embodiment;

FIG. 3 illustrates an exploded perspective view from above of a modular foam arrangement and a portion of a pneumatic bladder sub-assembly for a seat cushion in accordance with an exemplary embodiment;

FIG. 4 illustrates an exploded perspective view from below of the modular foam arrangement and the portion of the pneumatic bladder sub-assembly depicted in FIG. 3;

FIG. 5 illustrates an exploded perspective view from below of a modular foam arrangement and a portion of a pneumatic bladder sub-assembly for a seat cushion in accordance with an exemplary embodiment;

FIG. 6 is a cross-sectional view of the modular foam arrangement and the portion of the pneumatic bladder sub-assembly depicted in FIG. 5;

FIG. 7 illustrates a top view of a massage movement pattern of a portion of a pneumatic bladder sub-assembly in accordance with an exemplary embodiment;

FIG. 8 illustrates a top view of a massage movement pattern of a portion of a pneumatic bladder sub-assembly in accordance with an exemplary embodiment;

FIG. 9 illustrates a perspective view of a portion of a pneumatic bladder sub-assembly in accordance with an exemplary embodiment; and

FIG. 10 illustrates a method for fabricating a seat assembly in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

Various embodiments contemplated herein relate to seat assemblies and methods for fabricating seat assemblies. The exemplary embodiments taught herein provide a seat assembly including a seat frame and one or more seat cushions, such as a seat base cushion and/or a seat backrest cushion, supported by the seat frame. The seat cushion includes a modular foam arrangement and a pneumatic bladder sub-assembly that is operatively coupled to the modular foam arrangement. The modular foam arrangement includes a plurality of modular foam sections that are coupled together. In one example, the modular foam sections have a plurality of positive and negative features that function as interlocking features that are correspondingly engaged with each other to couple the modular foam sections together. In an exemplary embodiment, the modular foam sections are at least partially covered by an outer covering and include a first modular foam section that is disposed immediately adjacent to the outer covering.

The pneumatic bladder sub-assembly includes a plurality of bladder cells each configured to independently expand and contract to produce movement. The pneumatic bladder sub-assembly and the modular foam arrangement cooperate to translate or otherwise communicate the movement from the bladder cells to the first modular foam section.

The seat assembly is configured such that when a seat occupant is seated in the seat assembly, one or more body regions of the seat occupant are positioned on the outer covering of the seat cushion on a side opposite the first modular foam section. In an exemplary embodiment, it has been found that by translating movement from the pneumatic bladder sub-assembly to the first modular foam section, pressure between the seat cushion and the body regions of the seat occupant can be varied to create a rejuvenating or massaging effect, thereby improving blood flow in the corresponding body regions of the seat occupant to provide a more comfortable seat cushion. Further, by forming the seat cushion including modular foam sections that are coupled together using interlocking features that engage with each other, the use of adhesive to couple the different modular foam sections together can be reduced or eliminated to produce a more comfortable seat cushion.

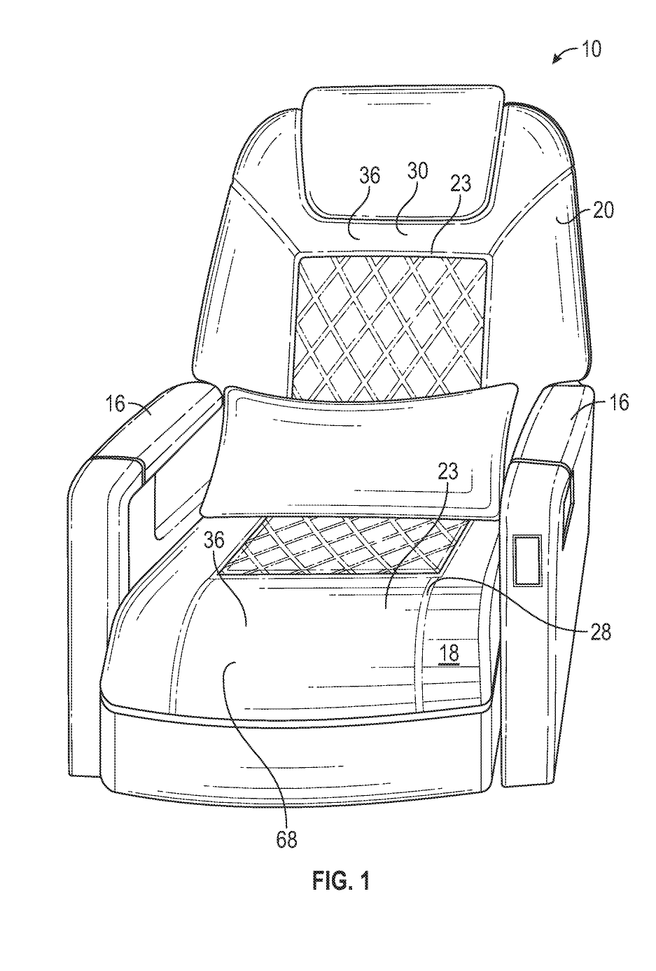

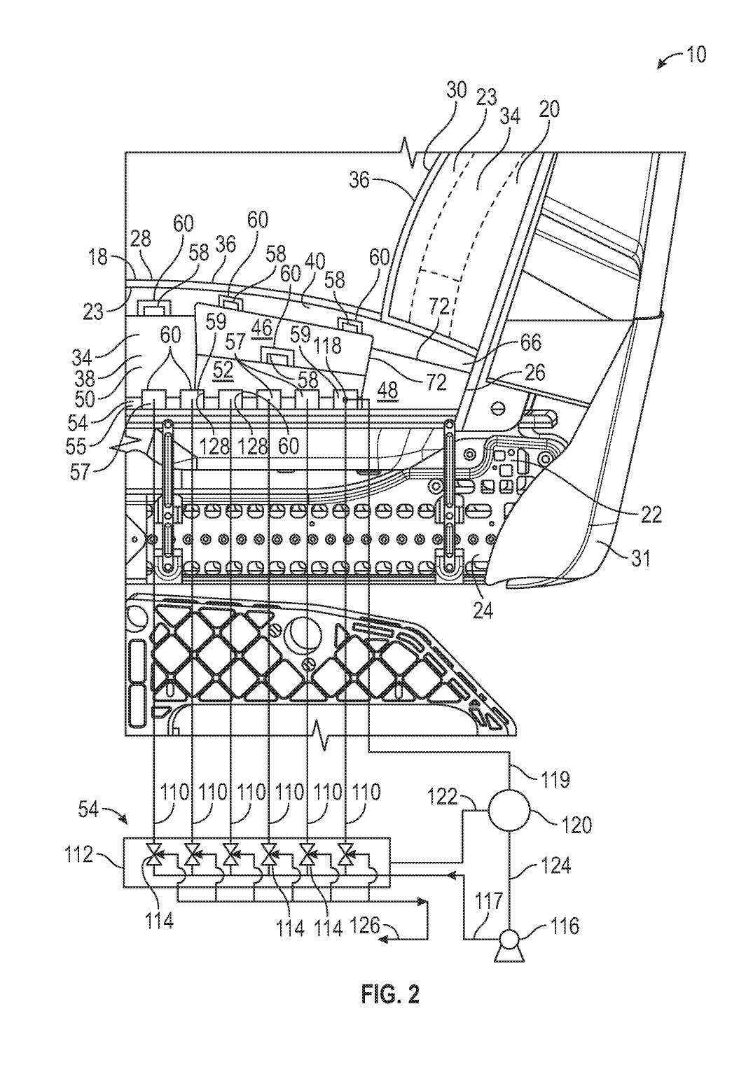

FIG. 1 illustrates a perspective view of a seat assembly 10 in accordance with an exemplary embodiment. FIG. 2 is a side view of a portion of the seat assembly 10 depicted in FIG. 1. Referring to FIGS. 1-2, the seat assembly 10 has a seat base portion 18 and a seat backrest portion 20 that extends substantially upright from the seat base portion 18. In one example, the seat backrest portion 20 is fixedly coupled to the seat base portion 18 such that the seat backrest portion 20 is permanently set in a substantially upright configuration. In another example, the seat assembly 10 is an adjustable seat assembly in which the seat backrest portion 20 is pivotably coupled to the seat base portion 18 for movement between a substantially upright position and, for example, a substantially reclined and/or inclined (e.g., forward leaning) position(s).

As illustrated, the seat assembly 10 includes a seat frame 22 for supporting the seat assembly 10 including supporting armrest portions 16 and a plurality of seat cushions 23. The seat frame 22 is formed of a relatively rigid support material such as metal, e.g., aluminum or the like, composite, or any other frame structure material(s) known to those skilled in the art.

The seat frame 22 includes a seat base structure portion 24 and a seat backrest structure portion 26 that is operatively coupled (e.g., fixedly coupled or pivotably coupled) to the seat base structure portion 24 to extend in a substantially upright position from the seat base structure portion 24. The seat base structure portion 24 of the seat frame 22 supports a seat base cushion 28 (e.g., one of the seat cushions 23) that together form at least part of the seat base portion 18 of the seat assembly 10. Likewise, the seat backrest structure portion 26 of the seat frame 22 supports a seat backrest cushion 30 (e.g., another of the seat cushions 23) that together form at least part of the seat backrest portion 20 of the seat assembly 10. Various other trim and/or shell panels or components 31 may be directly or indirectly coupled to the seat frame 22 to form any remaining parts or sections of the seat base portion 18 and/or the seat backrest portion 20 of the seat assembly 10.

As will be discussed in further detail below, the seat base and backrest cushions 28 and 30 are each formed of relatively flexible and/or soft materials such as a foam material(s) 34 that is covered or at least partially covered with an outer covering 36. The outer covering 36 is a relatively flexible and/or soft skin material such as leather, cloth or textile fabric (e.g., woven or knitted construction), thermoplastic skin material such as TPO, PVC, or the like. The outer covering 36 may be formed using a conventional leather forming process, a thermoforming process, a slush or rotational molding process, and/or any other conventional process for forming an interior trim outer skin covering that is relatively flexible and/or soft.

Referring to FIGS. 1-4, in an exemplary embodiment, the foam material(s) 34 in the seat base cushion 28 is configured as multiple modular pieces or modular foam sections 40, 42, 44, 46, 48, 50, 52, and 56 that are coupled together to form a modular foam arrangement 38. As illustrated, the modular foam section 40 is an exterior modular foam section disposed along an outer-most portion of the modular foam arrangement 38 adjacent to and underlying the outer covering 36. The modular foam section 40 extends from a rearward section 66 of the seat base portion 18, which lies under the seat backrest portion 20, generally forward to a forward section 68 of the seat base portion 18. The modular foam section 40 has a down-standing flange 70 that wraps around the forward section 68 immediately adjacent to the outer covering 36. As such, the modular foam section 40 forms a portion of the modular foam arrangement 38 of the seat base cushion 28 that is disposed most proximate to a seat occupant.

The remaining modular foam sections 42, 44, 46, 48, 50, 52, and 56 are interior modular foam sections that are disposed in the interior portion of the modular foam arrangement 38 underneath the modular foam section 40. As illustrated, the modular foam sections 42, 44, 46, 48, 50, and 56 are disposed immediately adjacent to the modular foam section 40 along a side opposite the outer covering 36, while the modular foam section 52 is spaced apart from the modular foam section 40 in a further interior portion of the modular foam arrangement 38.

A pneumatic bladder sub-assembly 54 includes a bladder cell sub-assembly 55 that is disposed in the seat base cushion 28. In an exemplary embodiment, the bladder cell sub-assembly 55 underlies and is coupled to the modular foam arrangement 38 and is supported by the seat base structure portion 24 of the seat frame 22.

As illustrated, the bladder cell sub-assembly 55 is formed of a sheet-like material (e.g., elastomeric material or the like) and includes a plurality of bladder cells 57 each having an inflatable chamber 59 formed therein. The inflatable chambers 59 can be inflated or deflated with fluid, e.g., air or the like, to independently expand and contract each of the bladder cells 57 to produce movement.

In an exemplary embodiment, each of the inflatable chambers 59 is connected to a feed line 110 by which a fluid can be introduced into the inflatable chamber 59 or released from the inflatable chamber 59. In one example, the feed lines 110 are connected to a valve block 112 that includes a plurality of valves 114. A fluid source 116 is in fluid communication with the valve block 112 via line 117 for selectively providing fluid, e.g., air or the like, to each of the valves 114. Non-limiting examples of the fluid source 116 include a pump, a compressed air system, or the like. In an exemplary embodiment, each of the inflatable chambers 59 have a pressure sensor 118 disposed therein for monitoring the pressure of the inflatable chamber 59. The pressure sensors 118 are in communication via lines 119 with a controller 120. The controller 120 is configured to send a signal(s) via line(s) 122 and/or 124 to the valve block 112 and/or the fluid source 116 for inflating or deflating each of the inflatable chambers 59 to independently expand and contract each of the bladder cells 57, thereby producing movement. For example, when a particular inflatable chamber 59 is to be inflated, the controller 120 sends a signal via the line 122 to the valve block 112 and the associated valve 114 opens to direct fluid from the fluid source 116 along the associated feed line 110 to the inflatable chamber 59 for inflation. Likewise, when a particular inflatable chamber 59 is to be deflated, the controller 120 sends a signal via the line 122 to the valve block 112 and the associated valve 114 (e.g., 3-way valve) opens to allow fluid from the inflatable chamber 59 to be passed back along the associated feed line 110 to the valve 114 which directs the fluid along line 126 to be released, removed, or otherwise exhausted.

In an exemplary embodiment, the pneumatic bladder sub-assembly 54 and the modular foam arrangement 38 are cooperatively configured to translate movement from the bladder cells 57 though the modular foam arrangement 38 to the modular foam section 40, which is adjacent to the outer covering 36, for providing a rejuvenating or massaging effect to a seat occupant. In particular, at least some of the modular foam sections 40, 42, 44, 46, 50, and 52 correspondingly have interlocking features 58 and 60 that engage the interlocking features 58 and 60 of one or more of the other adjacent modular foam sections 40, 42, 44, 46, 50, and 52 for coupling the modular foam sections 40, 42, 44, 46, 50, and 52 together, thereby helping movement produced from the bladder cells 57 to be efficiently translated through the modular foam arrangement 38 to the modular foam section 40. For example, movement from the bladder cells 57 is translated to the modular foam section 52, which translates the movement to the modular foam section 46, aided at least in part from the interaction between the interlocking features 58 and 60, which translates the movement to the modular foam section 40, aided again at least in part from the interaction between the interlocking features 58 and 60.

In an exemplary embodiment, the interlocking features 60 are negative features such as recesses or holes, and the interlocking features 58 are positive features such as projections or bosses that engage with the negative features. In one example, the interlocking features 58 can independently be configured as a boss having a substantially cylindrical-shape, and the interlocking features 60 can independently be configured as a hole having a substantially cylindrical shape for receiving and engaging the interlocking features 58. In another example, the interlocking features 58 can independently be configured as a boss having a substantially polygonal box-shape (e.g., cuboid-shape), and the interlocking features 60 can independently be configured as a hole having a substantially polygonal shape (e.g., cuboid-shape) for receiving and engaging the interlocking features 58.

In an exemplary embodiment, the pneumatic bladder sub-assembly 54 has a plurality of positive massage features 128 that engage with the negative features or the interlocking features 60 of the modular foam sections 50 and 52 that overlie the bladder cell sub-assembly 55 to help translate movement from the bladder cells 57 to the modular foam arrangement 38. For example, as the bladder cells 57 expand and contract, the movement produced therefrom is translated from the bladder cell sub-assembly 55 to the adjacent modular foam sections 50 and 52 via the positive massage features 128 interacting with the interlocking features 60 of the modular foam sections 50 and 52. As discussed above, the movement is further translated from the modular foam sections 50 and 52 to the overlying modular foam sections 40, 42, 44, and 46 for providing a rejuvenating or massaging effect to a seat occupant.

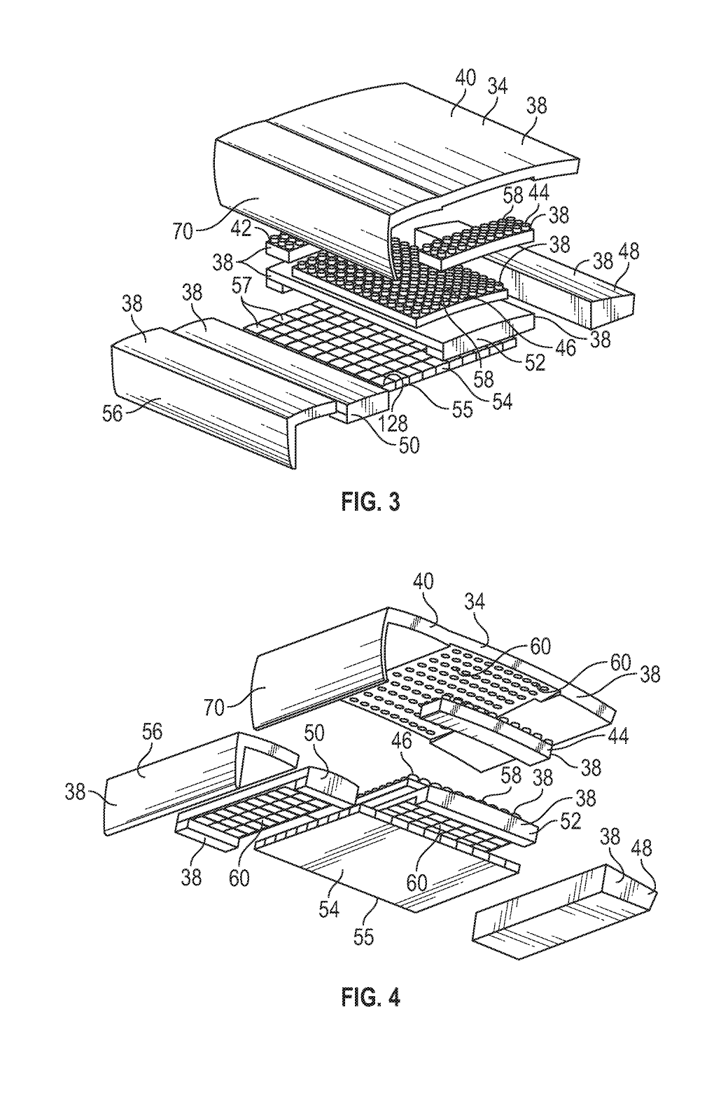

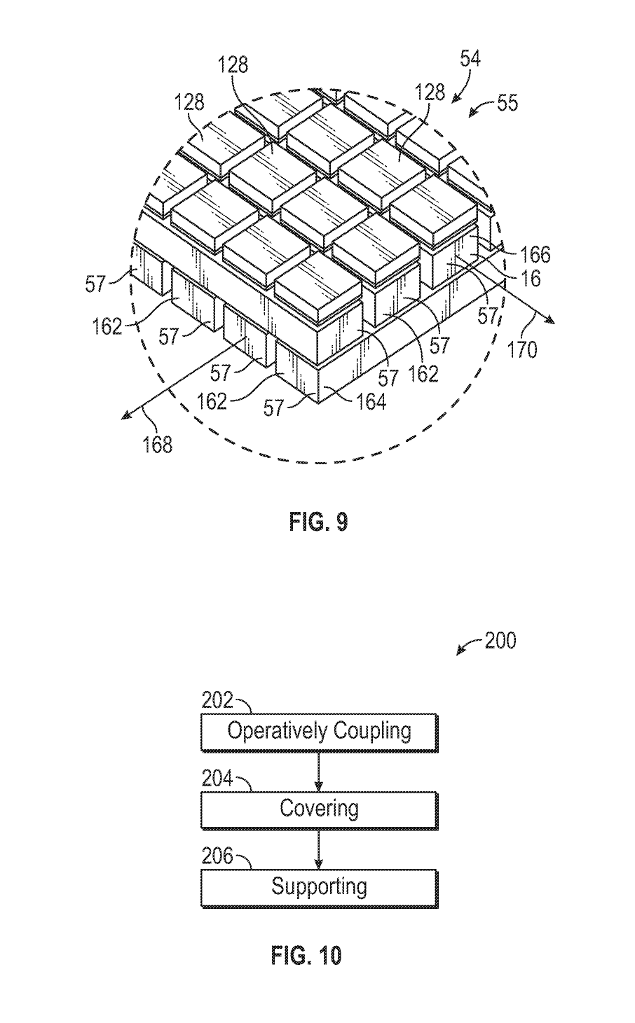

Referring to FIGS. 2-3, in an exemplary embodiment, the bladder cells 57 are configured as the positive massage features 128. As illustrated, the bladder cells 57 each have a cuboid shape and are arranged in a rectilinear crisscross pattern. Likewise, the negative features or the interlocking features 60 of the modular foam sections 50 and 52 are configured as holes arranged in a rectilinear crisscross pattern and have a substantially polygonal shape (e.g., cuboid-shape) for receiving and engaging the cuboid shape of the positive massage features 128. Alternatively, and as will be discussed in further detail below with reference to FIG. 9, the positive massage features 128 may be operatively coupled (e.g., bonded, affixed, or otherwise attached) to the bladder cells 57.

Referring to FIGS. 2-4, the modular foam sections 40, 42, 44, 46, 48, 50, 52, and 56 may be formed from the same type of foam or different types of foam. For example, one or more of the modular foam sections 40, 42, 44, 46, 48, 50, 52, and 56 may be formed from a thermoset type material (e.g., polyurethane or polyurea type foam material) based on conventional foam forming techniques of reacting two or more components, such as, for example, by reacting polyols with diisocynates in the presence of a foaming agent. Alternatively, one or more of the modular foam sections 40, 42, 44, 46, 48, 50, 52, and 56 may be formed from a thermoplastic material (e.g., polyolefin type foam) based on conventional foam forming techniques of foaming thermoplastic materials, such, as, for example, by saturating a thermoplastic material with liquid nitrogen and decompressing the liquid nitrogen saturated-thermoplastic material in an autoclave to form a thermoplastic foam.

The modular foam sections 40, 42, 44, 46, 48, 50, 52, and 56 may be fabricated by initially forming one or more foam blocks using one or more conventional foam forming processes, such as those discussed above or by any other foam forming process known to those skilled in the art. In an exemplary embodiment, the one or more foam blocks are then cut, milled, and/or otherwise trimmed using a computer numerical control (CNC) process to form, for example, the intricate shapes that define the modular foam sections 40, 42, 44, 46, 48, 50, 52, and 56 including the corresponding interlocking features 58 and 60.

The one or more of the modular foam sections 40, 42, 44, 46, 48, 50, 52, and 56 may have a different foam density than one or more of the other modular foam sections 40, 42, 44, 46, 48, 50, and 56. In an exemplary embodiment, the modular foam section 40, which is the exterior modular foam section, has a lower foam density and the remaining interior modular foam sections, specifically the modular foam sections 42, 44, 46, 48, 50, 52, and 56. In an exemplary embodiment, the modular foam section 40 has a relatively ultralow foam density, the modular foam sections 42, 44, 46, and 56 have a relatively low foam density, the modular foam sections 48 and 50 have a relatively medium foam density, and the modular foam section 52 has a relatively high foam density. As used herein, the terms “relatively ultralow foam density,” “relatively low foam density,” “relatively medium foam density,” and “relatively high foam density” are relative terms for comparing the foam densities between the different modular foam sections 40, 42, 44, 46, 48, 50, 52, and 56 of the modular foam arrangement 38.

In an exemplary embodiment, the relative foam density of a particular modular foam section 40, 42, 44, 46, 48, 50, 52, and 56 corresponds to its relative softness/hardness. That is, the modular foam section 40 having a relatively ultralow foam density is softer or less hard than the other modular foam sections 42, 44, 46, 48, 50, 52, and 56. Likewise, the modular foam sections 42, 44, 46, and 56 are softer or less hard than the modular foam sections 48 and 50, which are softer or less hard than the modular foam section 52. In an exemplary embodiment, it has been found that by having the more interior modular foam sections that are proximate to the bladder cell sub-assembly 55 (e.g., modular foam sections 50 and 52) formed of foam material(s) 34 having a relatively higher foam density (e.g., relatively hard or less soft) than the foam material(s) 34 of the less interior or exterior modular foam section(s) (e.g., modular foam section 46 followed by modular foam section 40), that movement from the bladder cells 57 can be more effectively translated through the modular foam arrangement 38 to the modular foam section 40 for providing a rejuvenating or massaging effect to a seat occupant.

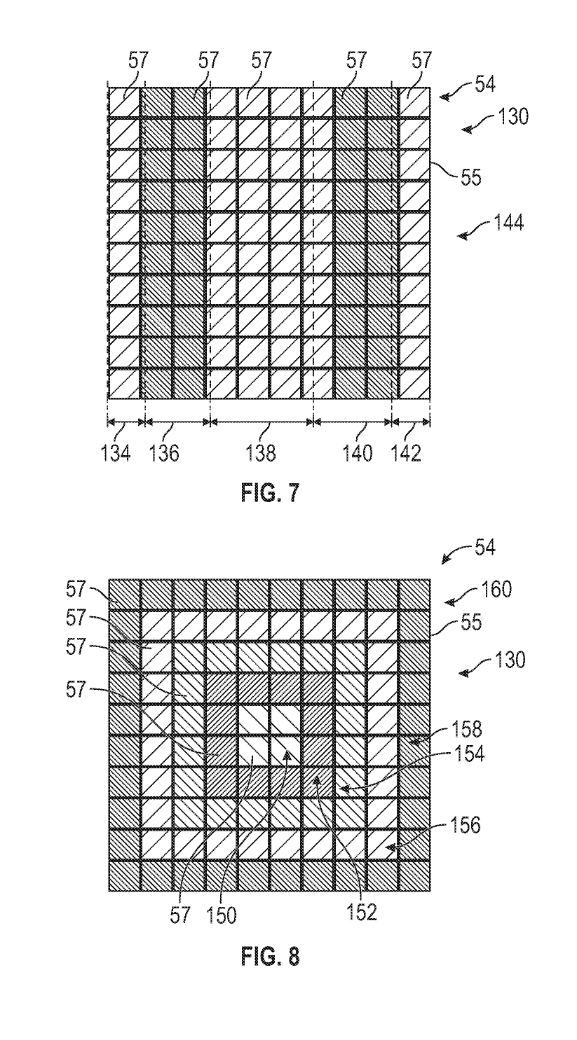

Referring to FIGS. 7-8, in an exemplary embodiment, the pneumatic bladder sub-assembly 54 is configured such that the expansion and contraction of the bladder cells 57 of the bladder cell sub-assembly 55 cooperate to produce a movement that corresponds to a massage movement pattern 130. In one example and as illustrated in FIG. 7, the bladder cells 57 of the bladder cell sub-assembly 55 are arranged in a plurality of longitudinal zones including a first longitudinal zone (indicated by double headed arrow 134), a second longitudinal zone (indicated by double headed arrow 136), a third longitudinal zone (indicated by double headed arrow 138), a fourth longitudinal zone (indicated by double headed arrow 140), and a fifth longitudinal zone (indicated by double headed arrow 142). The longitudinal zones 134, 136, 138, 140, 142 extend in substantially parallel longitudinal directions across the bladder cell sub-assembly 55. In an exemplary embodiment, the bladder cells 57 in each of the longitudinal zones 134, 136, 138, 140, and 142 expand and contract in synchronization with the other bladder cells 57 in the same respective longitudinal zone 134, 136, 138, 140, and 142 to produce the massage movement pattern 130 that corresponds to a ruled wave pattern 144. The ruled wave pattern 144 moves as a series of longitudinal extending waves that advance along the bladder cell sub-assembly in a direction that is substantially traversed to the longitudinal directions of the longitudinal zones 134, 136, 138, 140, and 142.

In another example and as illustrated in FIG. 8, the bladder cells 57 of the bladder cell sub-assembly 55 are arranged in a plurality of concentric zones including a first concentric zone (indicated by double headed arrow 150), a second concentric zone (indicated by double headed arrow 152), a third concentric zone (indicated by double headed arrow 154), a fourth concentric zone (indicated by double headed arrow 156), and a fifth concentric zone (indicated by double headed arrow 158). The concentric zones 150, 152, 154, 156, and 158 share a common center point and may further have common but different size shapes, e.g., circular shapes, oval shapes, polygon shapes such as squares, rectangles, triangles, or the like). In an exemplary embodiment, the bladder cells 57 in each of the concentric zones 150, 152, 154, 156, and 158 expand and contract in synchronization with the other bladder cells 57 in the same respective concentric zone 150, 152, 154, 156, and 158 to produce the massage movement pattern 130 that corresponds to a concentric wave pattern 160. The concentric wave pattern 160 moves as a series of waves that either advance towards the common center or away from the common center, for example as ripples of waves moving outward formed from a single drop of rain falling into a still pool of water.

Referring to FIG. 9, in an exemplary embodiment, the bladder cells 57 of the bladder cell sub-assembly 55 are configured as a plurality of juxtaposed elongated bladder cells 162. A first portion of the juxtaposed elongated bladder cells 162 are arranged in a first layer 164. A second portion or remaining portion of the juxtaposed elongated bladder cells 162 are arranged in a second layer 166 that overlies the first layer 164. As illustrated, the juxtaposed elongated bladder cells 162 in the first layer 164 extend in substantially parallel directions to the longitudinal axis (indicated by single headed arrow 168). The juxtaposed elongated bladder cells 162 in the second layer 166 extend in substantially parallel directions to the longitudinal axis (indicated by single headed arrow 170) that are different than the substantially parallel directions 168 of the first layer 164. In an exemplary embodiment, the substantially parallel directions 168 of the first layer 164 of the juxtaposed elongated bladder cells 162 are traversed (e.g., substantially perpendicular) to the substantially parallel directions 170 of the second layer 166 of the juxtaposed elongated bladder cells 162. As illustrated and as discussed above, the positive massage features 128 are coupled to the juxtaposed elongated bladder cells 162 that are arranged in the second layer 166 in which multiple positive massage features 128 are disposed on each of the juxtaposed elongated bladder cells 162.

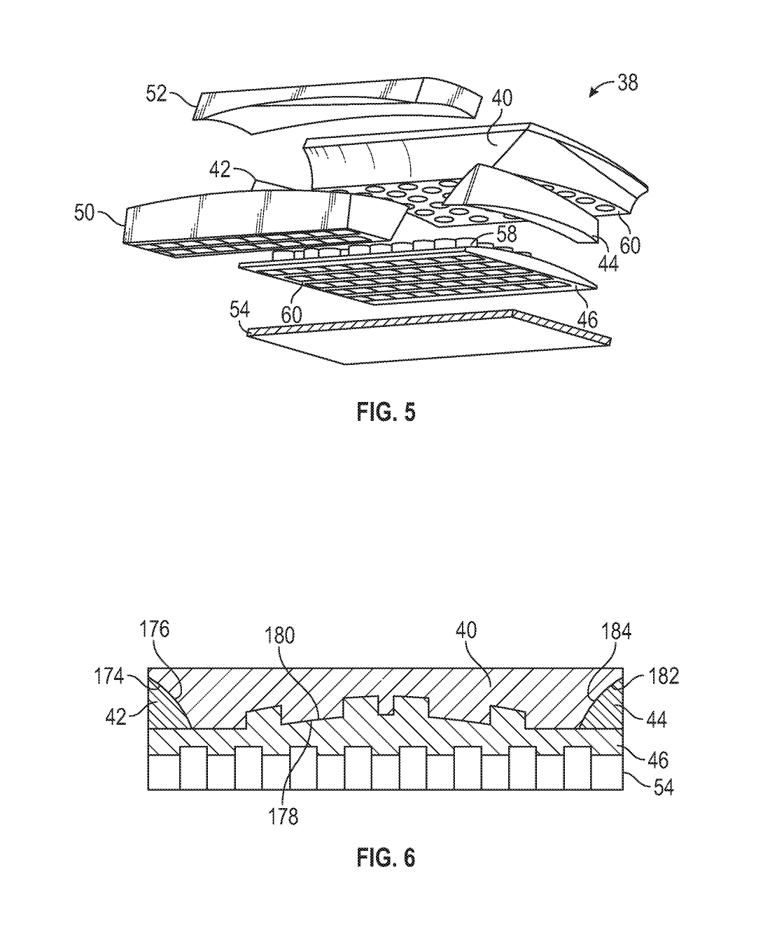

Referring to FIGS. 5-6, in an exemplary embodiment, the modular foam sections 40, 42, 44, and 46 of the modular foam arrangement 38 have matching curved surfaces 174, 176 178, 180, 182, and 184. For example, the modular foam section 40 has the matching curved surface 180 that faces toward and is matched with the matching curved surface 178 of the modular foam section 46. In particular, the matching curved surfaces 178 and 180 are highest at about the center portion of the modular foam arrangement 38 and taper downward towards the outboard portions of the modular foam arrangement 38. Further, the modular foam sections 42 and 44 have matching curved surfaces 174 and 182 that are respectively matched with the matching curved surfaces 176 and 184 of the modular foam section 40 along the outboard portions of the modular foam arrangement 38. As discussed in an embodiment above, the modular foam sections 42, 44, and 46 have a relatively higher foam density than the modular foam section 40. In an exemplary embodiment, it has been found that such a configuration facilitates the modular foam section 40, which is the modular foam section most proximate to a seat occupant, exhibiting non-uniform blustering with the modular foam sections 42 and 44 for reducing pressure point build-up on any adjacent body regions of a seat occupant resting on the seat base cushion 28 to provide a more comfortable seat cushion 23.

Referring to FIGS. 2-4, in an exemplary embodiment, the modular foam section 48 which is an interior modular foam section that is disposed in the rearward section 66 of the seat base portion 18 beneath the seat backrest portion 20, is affixed to the adjacent modular foam sections 40, 46, and 52 with an adhesive 72. As illustrated, no adhesive or substantially no adhesive (e.g., substantially free of adhesive) is present between the interfaces between the adjacent modular foam sections 40, 42, 44, 46, and 50 and the bladder cell sub-assembly 55, thereby reducing the amount of adhesive used in the modular foam arrangement 38 as compared to conventional seat cushions.

Referring to FIG. 2, the foam material(s) 34 in the seat backrest cushion 30 may be configured with a pneumatic bladder sub-assembly operatively coupled to modular foam sections with interlocking features, or alternatively, may be formed of a single piece of foam or multiple pieces of foam that are affixed together with an adhesive. In an exemplary embodiment, the seat backrest cushion 30 includes a modular foam arrangement and a pneumatic bladder sub-assembly similar configured to the modular foam arrangement 38 and the pneumatic bladder sub-assembly 54 as discussed above in relation to the seat base cushion 28.

Referring to FIG. 10, a method 200 for fabricating a seat assembly is provided. The method 200 includes operatively coupling (STEP 202) a pneumatic bladder sub-assembly to a first modular foam section of a modular foam arrangement. The pneumatic bladder sub-assembly includes a plurality of bladder cells each configured to independently expand and contract to produce movement for translation to the first modular foam section. The modular foam arrangement is at least partially covered (STEP 204) with an outer covering for forming a seat cushion. The seat cushion is supported (STEP 206) by a seat frame.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A seat assembly comprising:
a seat frame; and
a seat cushion supported by the seat frame and comprising:
a modular foam arrangement comprising a first modular foam section;
a pneumatic bladder sub-assembly coupled to the first modular foam section, the pneumatic bladder sub-assembly comprising a plurality of bladder cells each configured to independently expand and contract to produce movement that is communicated to the first modular foam section; and
an outer covering that at least partially covers the modular foam arrangement.

2. The seat assembly of claim 1, wherein the seat cushion is a seat base cushion.

3. The seat assembly of claim 1, wherein the seat cushion is a seat backrest cushion.

4. The seat assembly of claim 1, wherein the pneumatic bladder sub-assembly further comprises a fluid source in fluid communication with the bladder cells for providing fluid for expanding and contracting the bladder cells.

5. The seat assembly of claim 4, wherein the fluid source comprises one of a pump and a compressed air system.

6. The seat assembly of claim 4, wherein the pneumatic bladder sub-assembly further comprises at least one valve in fluid communication with the fluid source and at least one of the bladder cells for selectively providing fluid to the at least one of the bladder cells.

7. The seat assembly of claim 6, wherein the pneumatic bladder sub-assembly further comprises a valve block that is in fluid communication with the fluid source and the bladder cells and that comprises a plurality of valves including the at least one valve, and wherein the valve block is configured for selectively providing fluid to each of the bladder cells.

8. The seat assembly of claim 1, wherein the bladder cells are arranged in a rectilinear crisscross pattern.

9. The seat assembly of claim 1, wherein the bladder cells include a plurality of juxtaposed elongated bladder cells.

10. The seat assembly of claim 9, wherein the plurality of juxtaposed elongated bladder cells includes a first plurality of juxtaposed elongated bladder cells extending in substantially parallel first directions and a second plurality of juxtaposed elongated bladder cells that overlie the first plurality of juxtaposed elongated bladder cells and that extend in substantially parallel second directions that are different than the substantially parallel first directions.

11. The seat assembly of claim 1, wherein the modular foam arrangement has a plurality of negative features and the pneumatic bladder sub-assembly has a plurality of positive massage features, and wherein the positive massage features are engaged with the negative features to transfer the movement from the pneumatic bladder sub-assembly to the modular foam arrangement.

12. The seat assembly of claim 11, wherein the bladder cells are configured as the positive massage features.

13. The seat assembly of claim 11, wherein the positive massage features are coupled to one or more of the bladder cells.

14. The seat assembly of claim 1, wherein the pneumatic bladder sub-assembly further comprises a controller for controlling expansion and contraction of the bladder cells to produce the movement that corresponds to a massage movement pattern.

15. The seat assembly of claim 14, wherein the massage movement pattern includes one of a ruled wave pattern and a concentric wave pattern.

16. The seat assembly of claim 1, wherein the modular foam arrangement further comprises a second modular foam section disposed adjacent to the first modular foam section, wherein the pneumatic bladder sub-assembly is coupled to the second modular foam section to translate the movement to the second modular foam section, and wherein the first modular foam section has a negative feature and the second modular foam section has a positive feature disposed in the negative feature for translating the movement to the first modular foam section.

17. The seat assembly of claim 16, wherein the negative and positive features are interlocking features that are engaged to couple the first and second modular foam sections together.

18. The seat assembly of claim 16, wherein the first modular foam section has a first surface facing the second modular foam section and the second modular foam section has a second surface facing the first modular foam section, and wherein the first and second surfaces are matching curved surfaces that are coupled together.

19. A seat assembly comprising:
a seat base portion comprising a seat base structure portion and a seat base cushion supported by the seat base structure portion, wherein the seat base cushion comprises:
a modular foam arrangement comprising a first modular foam section;
a pneumatic bladder sub-assembly coupled to the first modular foam section, the pneumatic bladder sub-assembly comprising a plurality of bladder cells each configured to independently expand and contract to produce movement that is translate to the first modular foam section; and
an outer covering that at least partially covers the modular foam arrangement; and
a seat backrest portion coupled to the seat base portion and configured to extend substantially upright from a rearward section of the seat base portion, and wherein the first modular foam section overlies the pneumatic bladder sub-assembly and extends generally forward of the seat backrest portion.

20. A method for fabricating a seat assembly, the method comprising the steps of:
coupling a pneumatic bladder sub-assembly to a first modular foam section of a modular foam arrangement, wherein the pneumatic bladder sub-assembly comprises a plurality of bladder cells each configured to independently expand and contract to produce movement for translation to the first modular foam section;
at least partially covering the modular foam arrangement with an outer covering for forming a seat cushion; and
supporting the seat cushion by a seat frame.
